(19) United States
(12) Patent Application Publication
(10) Pub. No.: US 2015/0053820 A1
(43) Pub. Date: Feb. 26, 2015

(54) Line System for an Aircraft and Aircraft with a Line System

(71) Applicant: AIRBUS OPERATIONS GMBH, Hamburg (DE)

(72) Inventor: Christian Napp, Hamburg (DE)

(21) Appl. No.: 14/324,382

(22) Filed: Jul. 7, 2014

(30) Foreign Application Priority Data
Jul. 10, 2013 (DE) 10 2013 107 324.7

(51) Int. Cl. F16L 9/18; B64D 37/00

(52) U.S. Cl. CPC F16L 9/18; B64D 37/00
USPC 244/135 R; 138/114

(57) ABSTRACT

A line system for an aircraft comprises at least one double-walled fluid line with an outer line body, an inner line body arranged therein and at least one spacer. The outer line body and the inner line body are fluid-tight, wherein the inner line body is realized in one piece of a flexible material. The at least one spacer is arranged on at least one of the inner line body and the outer line body in order to space apart and/or electrically insulate the inner line body and the outer line body.

### TECHNICAL FIELD

The invention pertains to a line system for an aircraft and to an aircraft with such a line system.

### BACKGROUND OF THE INVENTION

In order to supply fuel to auxiliary power units (APU) in aircraft with a pressurized fuselage, it is common practice to utilize double-walled fuel lines that are connected to a fuel tank. In this case, the fuel flows in an inner line while the outer line serves for containing potentially occurring fuel leaks and for conveying the leaking fuel off-board the aircraft. APUs are frequently located in the tail of the respective aircraft and therefore require line lengths up to 30 m, wherein the fuel lines partially extend through the pressurized fuselage.

Double-walled fuel lines usually consist of several interconnected outer segments that are sealed several times at their connecting points. In addition, interconnected inner segments located in the outer segments define a gap relative to the outer segments and are also sealed several times.

### BRIEF SUMMARY OF THE INVENTION

The leakage check of conventional double-walled fuel lines includes the detection of a leak, e.g., by means of a visual inspection and/or corresponding sensors on a special device (“leak monitor”) that detect the presence of fuel in the outer line. In order to repair a leak, it is necessary to exchange the corresponding seals between two inner segments, wherein the detection of a leak, however, only provides information on that a leak in fact exists in the inner line, but not on the location of the leak. In order to find the exact location of the leak, it is necessary to carry out a dedicated manual inspection of the fuel line and of the seals, respectively.

An objective of the invention can be seen in reducing the effort for locating, dismounting and/or exchanging seals such that an efficient maintenance operation may be carried out when a leak occurs. This objective is met by a line system for aircraft with the features of independent claim 1. Advantageous embodiments and further improvements are disclosed in the dependent claims and the following description.

It is proposed a line system for an aircraft comprising at least one double-walled fluid line with an outer line body, an inner line body arranged therein and at least one spacer, wherein the outer line body and the inner line body are fluid-tight, wherein the inner line body is realized in one piece of a flexible material, and wherein the at least one spacer is arranged on at least one of the inner and the at least one outer line body in order to space apart and/or electrically insulate the inner line body and the outer line body.

The line system according to the invention therefore differs significantly from known line systems in aircraft because the inner line body consists of one piece and the complete dismounting of a segmented inner line is no longer required in case a leak is detected in the outer line body. Instead, it is now possible to locate the leak by disconnecting the inner line body from the respective tank and mechanically separating the inner line body from the outer line body by pulling it out of the outer line body in order to subsequently determine at which location of the inner line body the fluid escapes by acting upon the inner line body with a pressurized fluid. In this way, locating the leak is much more effectively and faster than in the prior art.

In order to install the inner line body in the outer line body, it is particularly advantageous to realize the inner line body of a flexible material, particularly a plastic. Due to its flexibility, the inner line body may be inserted into the free inner cross section of the outer line body on one of its ends in order to follow the course of the outer line body by being continuously advanced. When using a plastic material, for example in the form of an extruded hose, the surface may be realized very smooth and therefore with a particularly low coefficient of friction such that the inner line body may be easily inserted and shifted.

Thereby, the at least one spacer is to be arranged between the outer line body and the inner line body such that a predefined minimum clearance exists between the inner line body and the outer line body. The at least one spacer prevents an electrostatic charge from occurring due to large-surface friction between the inner line body and the outer line body when the inner line body is inserted. The at least one spacer serves as insulation between the inner line body and the outer line body. In a particularly advantageous solution, the at least one spacer is realized extremely thin in the form of an insulating layer that extends along the inner and/or the outer line body.

The term “in one piece” refers to the fact that the inner line body does not consist of many relatively short segments that only have a length, e.g., of two meters and need to be sealed relative to one another with corresponding seals on the respective ends, but rather of a single continuous line body. Accordingly, it is possible to realize lines of practically any length with one respective one-piece line. In the sectional manufacture of an aircraft fuselage, however, it is still possible to respectively equip individual sections with a separate one-piece line as part of the sectional division and to connect the separate one-piece lines to one another by means of a pressure-type connection or the like during the assembly of the sections into one fuselage. In a sectional manufacture, the inner line body may regularly reach lengths of approximately 10 m or more.

In an advantageous embodiment, the outer line body is flexurally rigid. It may therefore be installed along a predefined path within the aircraft in order to be subsequently penetrated by the inner line body without yielding to the motion of the inner line body. In contrast to flexibility, the term “flexurally rigid” refers to the low tendency to be bent under the influence of an external force. This is achieved by utilizing a closed profile contour, a thereby sufficiently high geometric moment of inertia and a high modulus of elasticity. The contour accuracy resulting thereof is also improved while an inner line body is pushed through. It should naturally be possible to arrange the outer line body on an aircraft structure in such a way that conventional fuselage deformations occurring during the operation of the aircraft do not lead to a fracture of the outer line body.

The outer line body preferably comprises a material from a group of materials, with said group comprising metallic material, thermosetting polymer, thermoplastic polymer and laminates in the form of fiber-reinforced and/or metal-reinforced plastics. High-strength and super high-strength light metal alloys such as, e.g., aluminum alloys, magnesium alloys and titanium alloys that make it possible to realize a flexural rigidity, but at the same time have a low weight, are particularly suitable for use in an aircraft. The additional advantage of a metallic design may be seen in the ability to be electrically connected to a ground potential or a ground in order to protect the inner line body lying therein from sparking, for example during a lightning strike. This may also be realized by choosing a suitable plastic, as well as by incorporating metallic components into a laminate structure.

It is furthermore conceivable and advantageous to likewise realize the outer line body in one piece. In this way, the outer line body may be quite easily and flatly integrated on a wall or a structure with a low weight and with low costs due to the eliminated seals. The lack of seals and the associated sealing surfaces furthermore eliminates potentially interfering edges, on which the inner line body may get caught while it is inserted. In a metallic design, the fact that the respective material is not available in unlimited dimensions and/or several changes in direction may still make it necessary to divide the outer line body and to only sectionally realize the outer line body in one piece, e.g., along straight sections.

In another advantageous embodiment, the inner line body consists at least on its outer side of a thermoplastic polymer that has a sufficient elasticity for being guided through an outer line body and, if suitably chosen, at the same time is preferably non-conductive or has a very high electric resistance in order to electrically insulate the two line bodies from one another and to inhibit sparking.

The inner line body and/or the at least one spacer may furthermore comprise a layer of a low-friction plastic on the outer side. This plastic may consist, for example, of PTFE (polytetrafluoroethylene) that has a particularly low coefficient of static friction and causes an improved gliding or sliding behavior, particularly in curves of the outer line body. It would also be possible to use a layer of PFA that may be processed in a thermoplastic fashion. Other plastics that drastically reduce the coefficient of friction may, in principle, also be considered.

The inner line body may preferably consist of a material composite that manifests itself, e.g., in the form of a multi-layer structure. The fuel-conveying inner surface of the inner line body, as well as the outer surface of the inner line body that comes in contact with the surroundings, may consist of a thermoplastic polymer. In order to achieve sufficient protection against pressure-related bursting, a shear load or a pulse-like compressive force or impact force, an aramid composite may be located between the thermoplastic layers. This aramid composite may comprise aramid fibers in the longitudinal and circumferential direction in the form of a woven aramid fabric that is surrounded by a matrix material. This matrix material needs to be adapted to the thermoplastic polymer on the inner and/or outer surface and could also correspond thereto (fiber-reinforced thermoplastic polymer). At this point, the plastics PA (polyamide), PTFE (polytetrafluoroethylene), PFA (perfluoroalkoxy copolymers), PEI (polyetherimide) and PEEK (polyetheretherketone) are cited merely as examples.

The inner line body furthermore may also consist of a metallic material or a thermosetting polymer if this may provide a sufficient flexibility. As described further below, the at least one spacer may extend over the entire length of the inner line body, particularly if a metallic material is used for the inner line body, in order to cause an electric insulation from the outer line body.

The inner line body should under all circumstances consist of a material or contain a material that has a defined electric conductivity such that sparking in the line system may be precluded under all circumstances such as a lightning strike, an electrostatic charge caused by the flowing fluid or the like. In addition to utilizing conductive particles in a layer of the inner line body that does not face the outer line body, it would also be conceivable to use incorporated metal threads or fabrics in case the inner line body does not comprise any other metallic material. Furthermore, the plastic used may itself have a certain conductivity. The specific resistance may amount, for example, to less than 20 KΩ/m.

In a particularly advantageous embodiment, a plurality of spacers are provided and preferably arranged equidistantly in the intermediate space between the outer line body and the inner line body. In order to largely prevent the inner line body from contacting the outer line body, it is advantageous to choose a clearance of 50 mm to 200 mm, preferably a clearance of approximately 100 mm.

It goes without saying that the at least one spacer preferably also consists of a non-conductive material or of a material with a very high electric resistance in order to prevent sparking between the outer line body and the inner line body and to achieve the lowest possible electrostatic charge. Since the at least one spacer comes in contact with the outer line body when the inner line body is inserted and pulled out, it should also have a particularly low coefficient of static friction such that the frictional force may always be overcome by additionally inserting the inner line body and the inner line body does not accumulate due to bending or buckling. The at least one spacer may furthermore also be equipped with a PTFE layer. The at least one spacer may likewise be made of all above-mentioned thermoplastic polymers.

It is advantageous to arrange the at least one spacer on an outer side of the inner line body. The at least one spacer may annularly extend around the inner line body and have a bead-shaped or dome-shaped or generally rounded cross-sectional contour. Due to the rounded shape, the inner line body may be reliably protected from jamming when it is inserted into or pulled out of the outer line body. The inner cross section of the outer line body is preferably larger than the outer cross section of the at least one spacer. Alternatively, it would be conceivable to completely encase the inner line body with an electrically insulating material such that the spacer would in the sense of the invention extend over the entire length of the inner line body.

As already mentioned above, the inner line body extends over a length of at least 10 m. In this way, entire sections or an entire aircraft fuselage may be equipped with a one-piece fuel line.

Due to the preferred utilization for a fuel line, the inner and the outer line body are realized in a fuel-resistant fashion. The respectively used material that comes in contact with the fuel therefore should remain permanently unaffected by fuel.

The objective of the invention is furthermore met by an aircraft with the features of the subordinate claim and the following description.

An aircraft comprises at least one engine, at least one fuel tank and at least one line system with the above-described characteristics. The outer line body preferably extends straight in the inventive aircraft and only comprises a few marginal changes in direction. In this way, the ability to install the line system is improved due to a simplified insertion of the inner line body into the outer line body. The force required for inserting the inner line body increases exponentially with the angle of a curve of the outer line body to be traversed and is calculated, for example, in accordance with the following formula for each individual curve i:

F_{R,j}=Fᵢ·e^{μα},

wherein F_{R,i} is the resulting frictional force, Fᵢ is the thrust at the beginning of the respective curve i, μ is the coefficient of static friction and α is the angle between the direction at the beginning and the direction at the end of the respective curve i. In designing the course of the outer line body, it therefore needs to be ensured that the entirety of the individual curves, as well as the straight sections lying in between, results in an overall frictional force that always may be reliably overcome by means of a thrust that is exerted upon the inner line body and may be transmitted by the material of the inner line body.

In an advantageous embodiment, the aircraft comprises an auxiliary power unit in a tail region of the aircraft and a fuel tank that is realized in the form of a central tank or wing tank, wherein the line system extends from the fuel tank to the auxiliary power unit. Since the distance to be traveled may amount to approximately 30 m, the inventive design of the line system is particularly suitable for the connection between an APU and a fuel tank. In segmented aircraft fuselages, in particular, the length of the inner line body amounts to at least 10 m.

### BRIEF DESCRIPTION OF THE FIGURES

Other characteristics, advantages and potential applications of the present invention result from the following description of exemplary embodiments and the figures. In this respect, all described and/or graphically illustrated characteristics also form the object of the invention individually and in arbitrary combination regardless of their composition in the individual claims or their references to other claims. In the figures, identical or similar objects are furthermore identified by the same reference symbols.

FIG. 1 shows a cross section and a longitudinal section through an inventive line system.

FIG. 2 shows a schematic side view of part of an aircraft with a line system installed therein.

### DETAILED DESCRIPTION

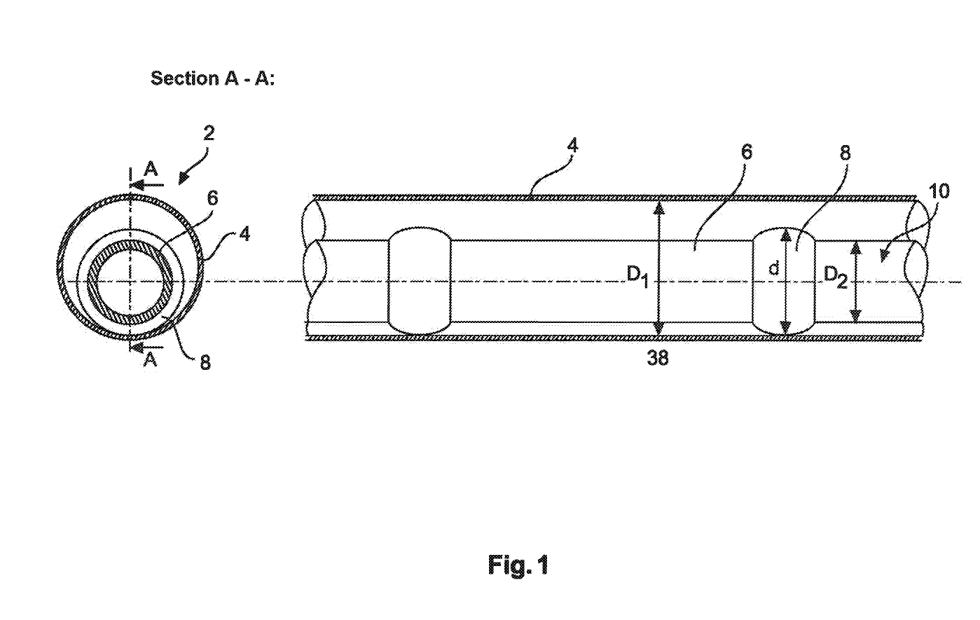

FIG. 1 shows a line system that comprises a double-walled fluid line with an outer line body 4 and an inner line body 6, as well as spacers 8. The schematic illustration shows two spacers 8 that are arranged on an outer surface area 10 of the inner line body 6. The largest outside diameter d of a spacer 8 is smaller than a diameter D₁ of a clear inner cross section of the outer line body 4 and larger than an outside diameter D₂ of the inner line body 6. The spacers 8 serve for realizing a minimum clearance and therefore an electric insulation between the inner line body 6 and the outer line body 4. In this way, for example, sparking between the outer line body 4 and the inner line body 6 may be inhibited and large-surface friction between the inner line body 6 and the inner surface of the outer line body 4 is simultaneously prevented. For example, the outer line body 4 could have an inside diameter D₁ of 30 mm to 40 mm whereas the spacer 8 could have a diameter of 25 mm to 30 mm. In this way, a certain mobility of the inner line body 6 is achieved during the insertion of the inner line body 6. The minimum clearance between the inner surface of the outer line body 4 and the surface area 10 of the inner line body 6 preferably could lie in the range between approximately 0 mm and 5 mm and, in particular, amount to at least 3 mm. The clearance may be practically reduced to 0 mm over the entire length if the spacer extends over the entire inner or outer line body in the form of an insulating layer and in addition to the insulation also protects against mechanical damages, e.g., due to friction.

The spacers 8 are realized, for example, annularly and have a profile contour parallel to a longitudinal direction of the inner line body 6 that continuously transforms from the outside diameter D₂ of the inner line section 6 into the maximum outside diameter d and is subsequently once again reduced to the outside diameter D₂ of the inner line body 6. Consequently, no sharp edges are created during the integration of the spacers 8 on the inner line body 6 such that jamming of the inner line section 6 is practically precluded.

The outer line body 4 is preferably realized in a flexurally rigid fashion and predefines the course of the inner line body 6. Flexurally rigid materials suitable for use in an aircraft are, in particular, aluminum alloys that furthermore are conductive and allow grounding of the outer line body 4. The inner line body 6, in contrast, should have a sufficient flexibility that, however, needs to be dimensioned such that the overall friction generated due to the insertion into the outer line body 4 may always be overcome by exerting thrust upon one end of the inner line body 6. This is intended to prevent the inner line body from bending or buckling on the “pushing” end such that a strong static friction between the inner line body 6 and the outer line body 4 resulting from the lateral force prevents the inner line body from being inserted further. In addition, one person should be able to carry out the insertion in the simplest possible fashion. The force therefore should preferably lie below 50 N. in order to prevent such blocking in a particularly advantageous fashion, the course of the outer line body 4 should be as straight as possible in order to counteract an increase of the friction due to directional changes in curves.

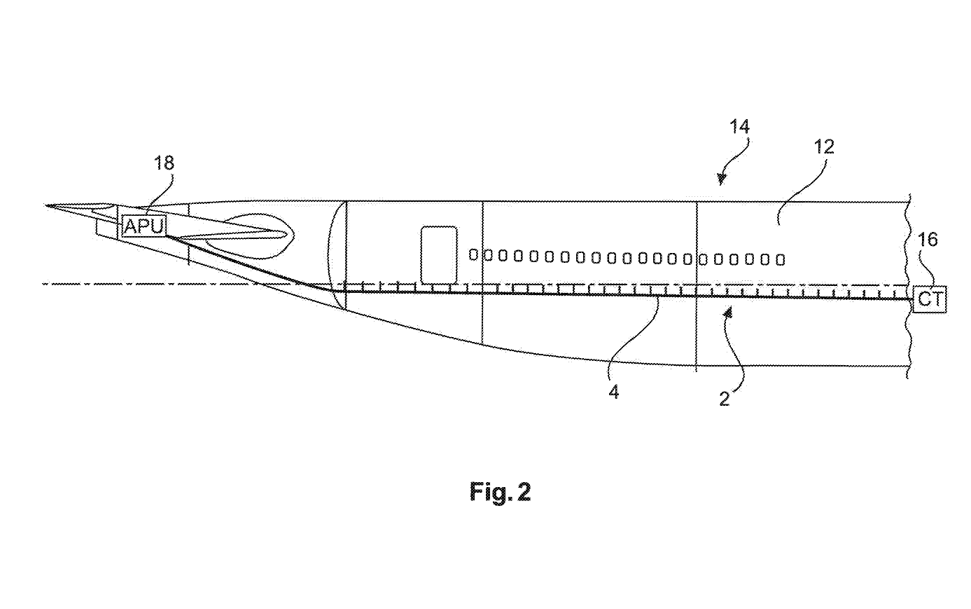

FIG. 2 shows a largely straight course of an outer line body 4 of a line system 2 in a fuselage 12 of an aircraft 14 in the form of a side view. In the illustration shown, the line system 2 is connected, for example, to a central tank 16 of the aircraft and feeds fuel to an APU 18. If a leak occurs in the inner line body 6, fuel is admitted into the outer line body 4 and may be detected optically or by means of sensors. The repair or exchange of the inner line body 6 is significantly simplified due to the inventive design and it is possible, e.g., to pull the entire inner line body 6 out of the outer line body 4 or to segmentally pull out and inspect the inner line body 6 in case the design is also subject to a segmentation due to a segmented design of the aircraft fuselage 12.

As a supplement, it should be noted that “comprising” does not exclude any other elements or steps, and that “a” or “an” does not exclude a plurality. It should furthermore be noted that characteristics described with reference to one of the above exemplary embodiments may also be used in combination with other characteristics of other above-described exemplary embodiments. Reference symbols in the claims should not be interpreted in a restrictive sense.

1. A line system for an aircraft, comprising at least one double-walled fluid line with an outer line body, an inner line body arranged therein and at least one spacer, wherein the outer line body and the inner line body are fluid-tight, wherein the inner line body is realized in one piece of a flexible material, and wherein the at least one spacer is arranged on at least one of the inner line body and the outer line body in order to space apart and/or electrically insulate the inner line body and the outer line body.

2. The line system of claim 1, wherein the outer line body is flexurally rigid.

3. The line system of claim 1, wherein the outer line body comprises a material from a group of materials, with said group comprising:
metallic materials,
thermosetting polymers,
thermoplastic polymers, and
laminates comprising at least one of fiber-reinforced plastics and metal-reinforced plastics.

4. The line system of claim 1, wherein the outer line body is realized in one piece.

5. The line system of claim 1, wherein the inner line body consists of a thermoplastic polymer at least on its outer side.

6. The line system of claim 1, wherein the inner line body and/or the spacer comprises a PTFE layer on its outer side.

7. The line system of claim 1, wherein the inner line body is electrically conductive.

8. The line system of claim 1, wherein the at least one spacer is arranged on the inner line body.

9. The line system of claim 8, comprising several spacers that are at least sectionally arranged equidistantly to one another.

10. The line system of claim 1, wherein the inner line body extends over a length of at least 10 m.

11. The line system of claim 1, wherein the inner line body is realized in a fuel-resistant fashion.

12. The line system of claim 1, wherein the inner line body is electrically conductive at least on one layer that is not directed toward its outer side.

13. An aircraft comprising at least one engine, at least one fuel tank and at least one line system, the line system comprising at least one double-walled fluid line with an outer line body, an inner line body arranged therein and at least one spacer, wherein the outer line body and the inner line body are fluid-tight, wherein the inner line body is realized in one piece of a flexible material, and wherein the at least one spacer is arranged on at least one of the inner line body and the outer line body in order to space apart and/or electrically insulate the inner line body and the outer line body.

14. The aircraft of claim 13, comprising an auxiliary power unit in a tail region of the aircraft and a fuel tank comprising a central tank or wing tank, wherein the line system extends from the fuel tank to the auxiliary power unit.

15. The aircraft of claim 14, wherein the length of the inner line body corresponds to at least 10 m.
